(19) United States
(12) Patent Application Publication
(10) Pub. No.: US 2026/0012067 A1
(43) Pub. Date: Jan. 8, 2026

(54) STEPPING MOTOR

(71) Applicant: AAC Microtech (Changzhou) Co., Ltd., Changzhou City (CN)

(72) Inventor: Lubin Mao, Changzhou (CN)

(21) Appl. No.: 18/964,663

(22) Filed: Dec. 1, 2024

Related U.S. Application Data
(63) Continuation of application No. PCT/CN2024/103187, filed on Jul. 2, 2024.

(51) Int. Cl. H02K 37/14; H02K 3/52; H02K 7/08

(52) U.S. Cl. CPC H02K 37/14; H02K 3/525; H02K 7/083; H02K 2203/03; H02K 2203/06

(57) ABSTRACT

The present disclosure discloses a stepping motor including a first cover plate, a second cover plate opposite to the first cover plate, a rotor configured to rotate relative to the stator, including a rotating shaft with both ends rotatably connected with the first cover plate and the second cover plate, and a magnet fixedly sleeved on the rotating shaft, a stator including at least two driving units arranged along an axis direction of the rotating shaft, and a circuit board. Each of the at least two driving units includes hollow cover coaxially with the rotating shaft and a driving system mounted on an inner surface of the cover. The circuit board is fixed on an outer surface of the cover. The inner surface of the cover is annular; the outer surface of the cover is rectangular.

### FIELD OF THE PRESENT DISCLOSURE

The present disclosure relates to motor technologies, especially relates to a stepping motor.

### DESCRIPTION OF RELATED ART

Stepping motor is commonly served as a workload driver in motor and generator.

In related art, the stepping motor includes a rotor and a stator wound around the rotor to drive the rotor. The stator includes a housing, a claw pole member fixed on the housing, and a winding wound on the claw pole member. The rotor includes a rotating shaft and a magnet sleeved on the rotating shaft. The magnet is interacted with the winding to generate driving force for the rotor. However, an outer surface of the housing is usually annular with low structure strength and large installation space. Besides, a lead wire of the winding is electrically connected with external circuit board by pins which also need extra installation space. Thus, the stepping motor cannot meet the miniaturization trend.

Therefore, it is necessary to provide an improved stepping motor to overcome the problems mentioned above.

### SUMMARY OF THE INVENTION

One object of the present disclosure is to provide a stepping motor easy to be assembled and having high strength cover.

The stepping motor includes a first cover plate; a second cover plate opposite to the first cover plate; a rotor configured to rotate relative to the stator, including: a rotating shaft with both ends rotatably connected with the first cover plate and the second cover plate; and a magnet fixedly sleeved on the rotating shaft; a stator spaced apart from and surrounding the rotor, including at least two driving units arranged along an axis direction of the rotating shaft; and a circuit board extended along the axis direction; wherein each of the at least two driving units includes hollow cover coaxially with the rotating shaft and a driving system mounted on an inner surface of the cover; the circuit board is fixed on an outer surface of the cover; the driving system is electrically connected with the circuit board; the inner surface of the cover is annular; the outer surface of the cover is rectangular.

As an improvement, the driving system includes a claw pole member fixed on the inner surface of the cover and surrounding the magnet, and a winding wound on the claw pole member, the winding is electrically connected with the circuit board.

As an improvement, a leakage hole arranged opposite to the circuit board is provided on the cover by penetrating thereon; a lead wire of the winding extends through the leakage hole to be electrically connected with the circuit board.

As an improvement, the circuit board includes a main body fixed on the cover, and a welding portion located on a side of the main body away from the cover; a plurality of through holes are provided on the main body; the lead wire of the winding is weld to the welding portion through the through hole.

As an improvement, further including a glue portion fixed on a surface of the circuit board away from the cover; the glue portion covers the welding portion.

As an improvement, the claw pole member includes a first claw pole and a second claw pole fixed on the cover and interacted with each other; the winding is simultaneously wound on the first claw pole and the second claw pole.

As an improvement, further including a first gasket and a second gasket sleeved on the rotating shaft; the first gasket and the second gasket are separately fixed on two ends of the magnet along the axis direction.

As an improvement, further including a first bearing mounted on the first cover plate, and a second bearing mounted on the second cover plate; the first bearing is sleeved on an end of the rotating shaft opposite to the first cover plate; the second bearing is sleeved on an end of the rotating shaft opposite to the second cover plate.

As an improvement, the magnet includes a plurality of magnetic parts arranged along a circumferential direction of the rotating shaft; two adjacent magnetic parts of the plurality of magnetic parts have same or opposite magnetization direction.

As an improvement, the cover is made of magnetic conductive material.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a stepping motor in accordance with an exemplary embodiment of the present disclosure.

FIG. 2 is an exploded view of partial of the stepping motor in FIG. 1.

FIG. 3 is an exploded view of the stepping motor in FIG. 1

FIG. 4 is a cross-sectional view of the stepping motor taken along line A-A in FIG. 1.

FIG. 5 is a cross-sectional view of the stepping motor taken along line B-B in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

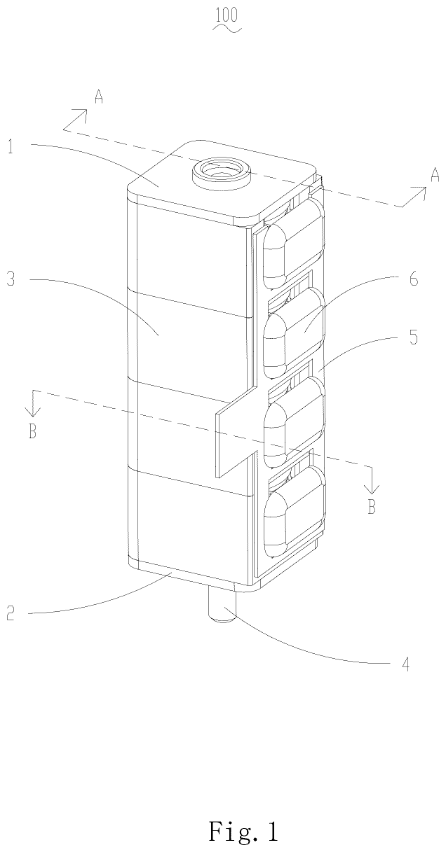

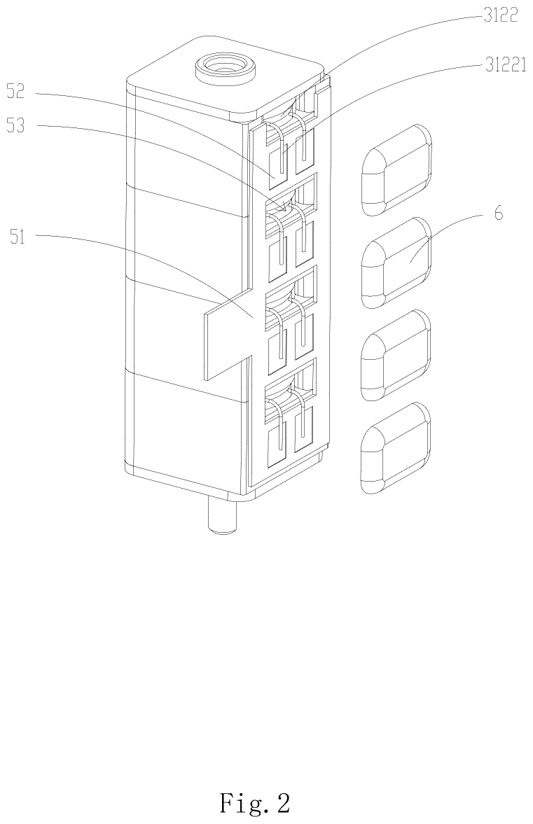

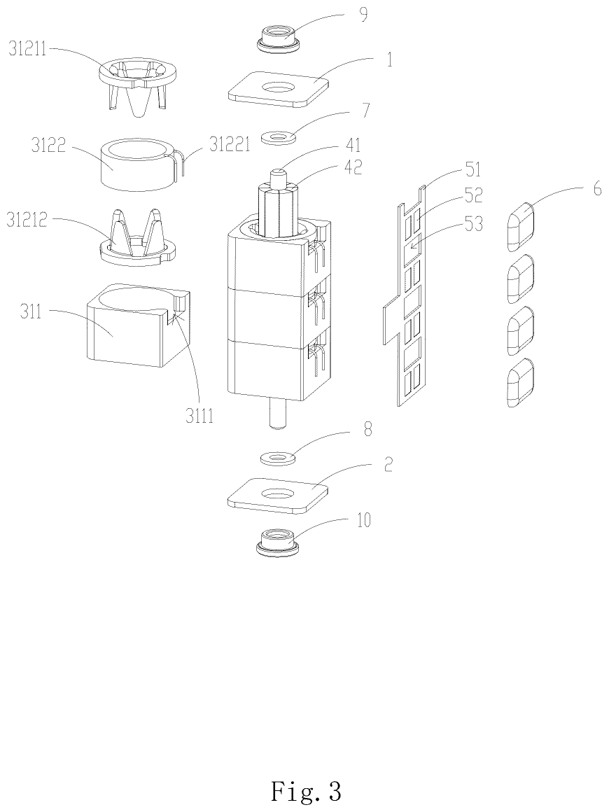

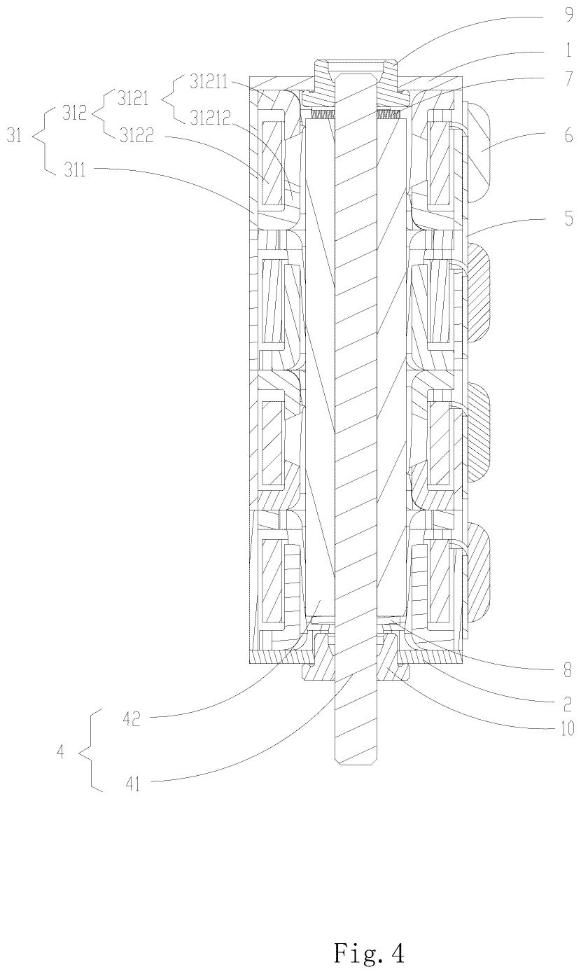

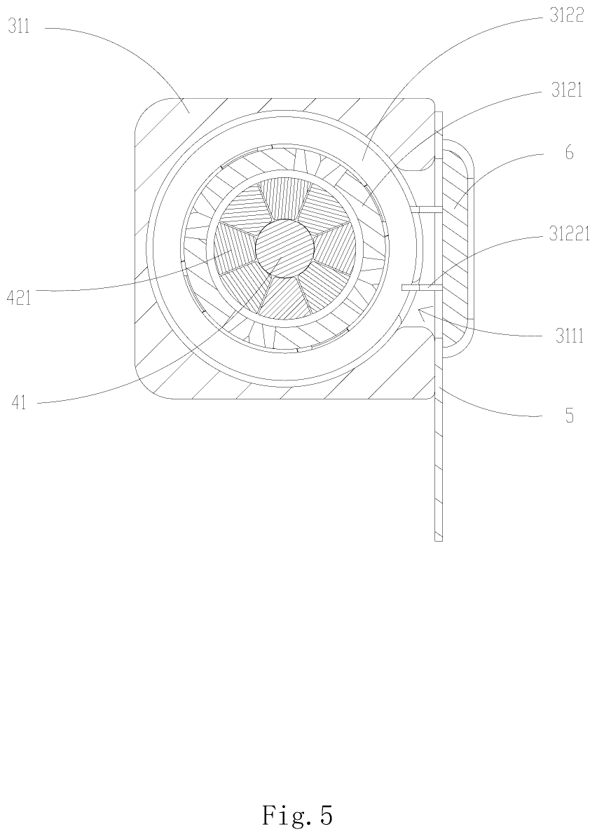

Please refer to FIGS. 1-5 together, a stepping motor 100 provided by an exemplary embodiment of the present disclosure includes a first cover plate 1, a second cover plate 2 opposite to the first cover plate 1, and a stator 3 and a rotor 4 sandwiched between the first cover plate 1 and the second cover plate 2. The rotor 4 is surrounded by the stator 3 and configured to rotate relative to the stator 3.

The rotor 4 includes a rotating shaft 41 with both ends rotatably connected with the first cover plate 1 and the second cover plate 2, and a magnet 42 fixedly sleeved on the rotating shaft 41.

The stepping motor 100 further includes a first gasket 7 and a second gasket 8 sleeved on the rotating shaft 41. The first gasket 7 and the second gasket 8 are separately fixed on two ends of the magnet 42 along the axis direction.

Specifically, the stepping motor 100 further includes a first bearing 9 mounted on the first cover plate 1, and a second bearing 10 mounted on the second cover plate 2. The first bearing 9 is sleeved on an end of the rotating shaft 41 opposite to the first cover plate 1. The second bearing 10 is sleeved on an end of the rotating shaft 42 opposite to the second cover plate 2. The magnet 42 includes a plurality of magnetic parts 421 arranged along a circumferential direction of the rotating shaft 41. Two adjacent magnetic parts 421 of the plurality of magnetic parts 421 have same or opposite magnetization direction.

In addition, the stator 3 includes at least two driving units 31 arranged along an axis direction of the rotating shaft 41. Each of the at least two driving units 31 includes hollow cover 311 coaxially with the rotating shaft 41 and a driving system 312 mounted on an inner surface of the cover 311. The inner surface of the cover 311 is annular. An outer surface of the cover 311 is rectangular. It should be noted that the cover 311 of each of the at least two driving units 31 is stacked along the axis direction and sandwiched between the first cover plate 1 and the second cover plate 2.

The stepping motor 100 further includes a circuit board 5 extended along the axis direction and fixed on the outer surface of the cover 311. The driving system 312 is electrically connected with the circuit board 5.

In one embodiment, the circuit board 5 is a flexible circuit board. The rectangular outer surface of the cover 311 allows the circuit board 5 to be fully fixed on, thus facilitating the assembly of the stepping motor 100.

Moreover, the driving system 312 includes a claw pole member 3121 fixed on the inner surface of the cover 311 and surrounding the magnet 42, and a winding 3122 wound on the claw pole member 3121. The winding 3122 is electrically connected with the circuit board 5.

A leakage hole 3111 arranged opposite to the circuit board 5 is provided on cover 311 by penetrating thereon. A lead wire 31221 of the winding 3122 extends through the leakage hole 3111 to be electrically connected with the circuit board 5.

The circuit board 5 includes a main body 51 fixed on the cover 311, and a welding portion 52 located on a side of the main body 51 away from the cover 311. A plurality of through holes 53 are provided on the main body 51. The lead wire 31221 of the winding 3122 is weld to the welding portion 52 through the through hole 53. The lead wire 31221 of the winding 3122 is prone to be weld on the welding portion 52 by extending through the leakage hole 3111 of the cover 311 and the through hole 53 on the circuit board 5, thus immensely reducing the occupancy of the lead wire structure of the winding 3122 in the stepping motor 100. In one embodiment, the stepping motor 100 further includes a glue portion 6 fixed on a surface of the circuit board 5 away from the cover 311. The glue portion 6 covers the welding portion 52 wholly to ensure the welding stability of the lead wire 31221.

The claw pole member 3121 includes a first claw pole 31211 and a second claw pole 31212 fixed on the cover 311 and interacted with each other. The winding 3122 is simultaneously wound on the first claw pole 31211 and the second claw pole 31212.

The cover 311 is made of magnetic conductive material.

In order to receive the claw pole member 3121 and the winding 3122, the inner surface of the cover 311 is annular. The cover 311 in the present disclosure including rectangular outer surface and annular inner surface has higher bending strength compared with common annular cover. It is prone to installation when being assembled to the mobile device. The magnetic conductive cover is capable of improving the motor torque of the stepping motor 100.

Compared with the related art, the stepping motor in the present disclosure includes a cover having a rectangular outer surface and an annular inner surface, thereby improving the bending strength of the stepping motor and further increasing the motor torque by providing a magnetic conductive cover. Besides, the rectangular outer surface of the cover facilitates the fixation of the circuit board to be mounted on, thus reducing the occupancy of the lead wire structure of the winding.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A stepping motor comprising:
a first cover plate;
a second cover plate opposite to the first cover plate;
a rotor configured to rotate relative to the stator, comprising:
a rotating shaft with both ends rotatably connected with the first cover plate and the second cover plate; and
a magnet fixedly sleeved on the rotating shaft;
a stator spaced apart from and surrounding the rotor, comprising at least two driving units arranged along an axis direction of the rotating shaft; and
a circuit board extended along the axis direction; wherein each of the at least two driving units comprises hollow cover coaxially with the rotating shaft and a driving system mounted on an inner surface of the cover; the circuit board is fixed on an outer surface of the cover;
the driving system is electrically connected with the circuit board;
the inner surface of the cover is annular; the outer surface of the cover is rectangular.

2. The stepping motor as described in claim 1, wherein the driving system comprises a claw pole member fixed on the inner surface of the cover and surrounding the magnet, and a winding wound on the claw pole member, the winding is electrically connected with the circuit board.

3. The stepping motor as described in claim 2, wherein a leakage hole arranged opposite to the circuit board is provided on the cover by penetrating thereon; a lead wire of the winding extends through the leakage hole to be electrically connected with the circuit board.

4. The stepping motor as described in claim 3, wherein the circuit board comprises a main body fixed on the cover, and a welding portion located on a side of the main body away from the cover; a plurality of through holes are provided on the main body; the lead wire of the winding is weld to the welding portion through the through hole.

5. The stepping motor as described in claim 4, further comprising a glue portion fixed on a surface of the circuit board away from the cover; the glue portion covers the welding portion.

6. The stepping motor as described in claim 2, wherein the claw pole member comprises a first claw pole and a second claw pole fixed on the cover and interacted with each other; the winding is simultaneously wound on the first claw pole and the second claw pole.

7. The stepping motor as described in claim 1, further comprising a first gasket and a second gasket sleeved on the rotating shaft; the first gasket and the second gasket are separately fixed on two ends of the magnet along the axis direction.

8. The stepping motor as described in claim 1, further comprising a first bearing mounted on the first cover plate, and a second bearing mounted on the second cover plate; the first bearing is sleeved on an end of the rotating shaft opposite to the first cover plate; the second bearing is sleeved on an end of the rotating shaft opposite to the second cover plate.

9. The stepping motor as described in claim 1, wherein the magnet comprises a plurality of magnetic parts arranged along a circumferential direction of the rotating shaft; two adjacent magnetic parts of the plurality of magnetic parts have same or opposite magnetization direction.

10. The stepping motor as described in claim 1, wherein the cover is made of magnetic conductive material.
